(19) United States
(12) Patent Application Publication
(10) Pub. No.: US 2012/0208146 A1
(43) Pub. Date: Aug. 16, 2012

(54) FLUTED REAMER COMPRISING A PLURALITY OF HELICAL CUTTING LIPS

(75) Inventor: Julien Mordeniz, Besancon (FR)

(73) Assignee: MICRO MEGA INTERNATIONAL MANUFACTURES, Besancon (FR)

(21) Appl. No.: 13/500,699

(22) PCT Filed: Oct. 6, 2010
(86) PCT No.: PCT/FR2010/052107

§ 371 Date: Apr. 6, 2012

(30) Foreign Application Priority Data
Oct. 8, 2009 (FR) 0957017

(51) Int. Cl. A61C 5/02

(52) U.S. Cl. 433/102

(57) ABSTRACT

A new reamer has a cut blade including a plurality of helical cutting lips, wherein a number of helical cutting lips varies along a longitudinal axis of the cut blade.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The invention relates to a fluted reamer comprising a cut blade comprising a plurality of helical cutting lips.

The invention is of particular value for the treatment of dental root canals.

2. Description of Related Art Including Information Disclosed Under 37 CFR 1.97 and 37 CFR 1.98.

The treatment of a dental root of which the tissues are damaged consists in extracting the pulp in order to clean out the canal, shape the canal and, to finish, close off the shaped canal, for example with Gutta-percha, paste and/or a sealing cement.

The shaping of the canal can be obtained by the “crown down” method which is summarized by the following actions in order: crown enlarging, canal preparation and apical finishing. These operations result in a canal that is more or less curved of conical shape the smallest diameter of which is situated at the apex (the terminal portion of the canal) and the largest diameter of which will be at the pulp floor (the starting point of the root canal).

From a practical point of view, in order to shape the canal according to the “crown down” method, reamers are used that comprise a cut blade comprising a plurality of helical cutting lips, extended by a manual handle or a mechanical handle designed to be rotated by a tool holder of the handpiece or contra-angle handpiece. More precisely, use is made in turn of a plurality of reamers with different geometric characteristics (tip diameter, conicity, pitch of helical cutting lips, shape of the section, etc.), and with different working lengths. The order of change of the various instruments is defined in a treatment protocol that is a function of the state and of the shape of the root to be treated. The change from a previous instrument makes it possible to considerably reduce the concentrations of effort and the screwing effects that would be applied to the next instrument.

The shaping of the canal according to this method is found to be inconvenient and time-consuming to carry out because of the necessity to change reamers several times.

### BRIEF SUMMARY OF THE INVENTION

The invention proposes a new fluted reamer comprising a cut blade comprising a plurality of helical cutting lips, wherein a number of helical cutting lips varies along a longitudinal axis of the cut blade.

Varying the number of cutting lips takes the form of an optimization of the stresses and a minimization of the screwing effects of the blade over the whole length of the canal. The cleaning and shaping of the canal can therefore be carried out with a single reamer according to the invention. Therefore, with a reamer according to the invention, the treatment of a root is quicker and less stressful: it is no longer necessary to change the reamer or to be concerned with the order of use of a series of reamers.

In the known reamers, on a given section of the blade orthogonal to the longitudinal axis of the blade, all the cutting lips have identical geometric characteristics, notably a helix pitch, a helix angle, a cutting angle, etc.

In the context of the invention, preferably, at least on a section of the blade orthogonal to the longitudinal axis of the cut blade, a helix pitch, a helix angle or a cutting angle of a cutting lip is different from the helix pitch, from the helix angle or from the cutting angle of the other cutting lips. Varying the helix pitch or the helix angle of one of the cutting lips independently of the helix pitch or of the helix angle of the other cutting lips is a solution for modifying the number of cutting lips, as will be better seen below in examples. The cutting angle is adjusted to optimize the effect of the cutting lip depending on the helix pitch and the helix angle.

Preferably, the cut blade of a reamer according to the invention comprises in turn, along the longitudinal axis of the blade:

a first portion in which the blade comprises a first number of helical lips having first identical geometric characteristics at an orthogonal section on an axis perpendicular to the longitudinal axis,

a second portion in which the geometric characteristics of the helical lips vary from one lip to the other,

a third portion in which the blade comprises a second number of helical lips having second identical characteristics at an orthogonal section, the second number and the second geometric characteristics being different from the first number and from the first geometric characteristics respectively.

In the first portion and in the third portion, the geometric characteristics of the lips may vary along the portion in question, but, if need be, the geometric characteristics remain identical from one lip to the other.

The second portion is a transition portion, in which at least one of the geometric characteristics of one of the lips of the blade is modified so that the number of cutting lips of the first portion is different from the number of cutting lips of the third portion, as will be better seen below in examples.

The geometric characteristics of a cutting lip that are likely to be varied are, for example:
a helix pitch, and/or
a helix angle, and/or
a cutting angle.

In one embodiment, the cut blade of a reamer according to the invention comprises three cutting lips in the first portion in the vicinity of the tip of the blade, and two cutting lips in the third portion in the vicinity of an end opposite to the tip of the blade. The blade may be substantially conical or cylindrical.

The cut blade may be extended by a fourth portion that is cylindrical and not cut. This portion provides greater flexibility to the reamer.

The cut blade, and optionally the fourth portion, may be extended by:
a manual handle, for a manual use of the reamer, or
a mechanical handle allowing the blade to be connected to a rotary driving tool, for a continuous or alternating rotation of the reamer.

### BRIEF DESCRIPTION OF THE SEVERAL VIEWS OF THE DRAWINGS

The invention will be better understood and other features and advantages of the invention will become evident in the light of the following description of an exemplary embodiment of a reamer according to the invention. This example is given as a nonlimiting example. The description should be read with reference to the appended drawings in which:

FIG. 1 is an overview of a reamer according to the invention,

FIGS. 2, 3A to 3E and 4 show the evolution of the section of the cut blade of the reamer of FIG. 1, a section along planes perpendicular to the longitudinal axis of the blade, FIG. 2 represents the section along the portion P1, FIGS. 3A to 3E represent the sections along the portion P2, FIG. 4 represents the section along the portion P3, and

FIG. 5 is a view of the cut blade of the reamer of FIG. 1.

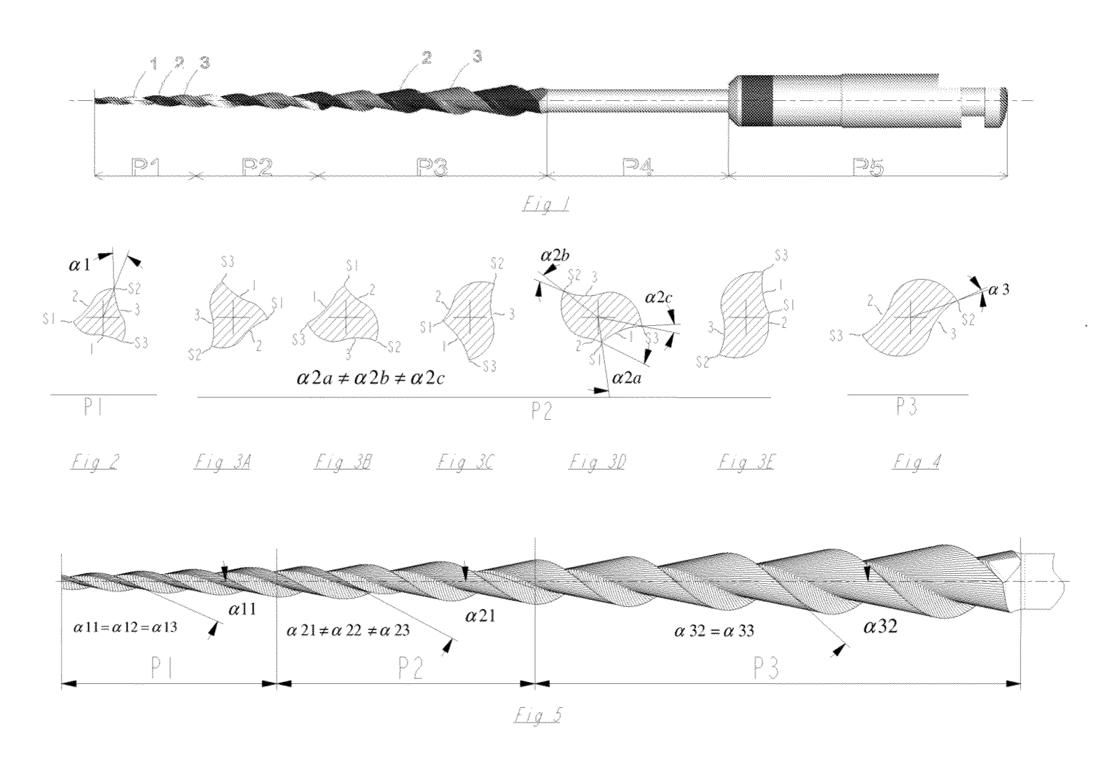

### DETAILED DESCRIPTION OF THE INVENTION

The reamer shown comprises a cut blade of substantially conical shape. The blade comprises three helical flutes, 1, 2, 3 in the vicinity of the blade tip and two helical flutes 2, 3 in the vicinity of the heel of the cut blade (the end opposite to the tip). The intersection of the flute 1 with the flute 2 forms the cutting lip S1, the intersection of the flute 2 with the flute 3 forms the cutting lip S2, the intersection of the flute 3 with the flute 1 forms the cutting lip S3. Each cutting lip extends helically along the blade. The blade comprises three cut portions.

In the first cut portion P1, the blade comprises three cutting lips all having identical geometric characteristics at a blade section (FIG. 2):
the same helix pitch,
the same helix angle alpha11=alpha12=alpha13
the same cutting angle alpha1

Two sections of the portion P1 can nevertheless have different geometric characteristics.

The length of the first portion P1 is in this instance approximately L1=2 to 6 mm (for example 4 mm), its small diameter is of the order of 0.1 to 0.4 mm (for example 0.2 mm) at the tip of the reamer and its large diameter is of the order of 0.15 to 0.8 mm (for example 0.5 mm) in the vicinity of the second portion. All the geometric characteristics of the first portion (the number of cutting lips, the pitch of the helixes, the cutting angle, the helix angle, the conicity, the length, the tip diameter, etc.) are adjusted to obtain the best distribution of the mechanical stresses in the blade and a good centering for the apical finishing.

The change in the number of helical lips occurs on the second cut portion P2 of the blade, by modifying independently the value of the pitch of each of the helical blades. Thus, at a section of the blade (FIGS. 3A, 3B, 3C, 3D or 3E):
at least one of the helixes has a pitch that is different from that of the other helixes,
the helix angles alpha21, alpha22, alpha23 are different, adjusted as a function of the variations in the pitches of the helixes for an optimal distribution of the mechanical stresses on the blade,
the cutting angles alpha2a, alpha2b, alpha2c are different; they are optimized at each section for an optimal cutting efficiency.

FIGS. 3A to 3E show the progressive evolution of the section of the blade in the portion P2, from the vicinity of the portion P1 (FIG. 3A) to the vicinity of the portion P3 (FIG. 3E). The evolution of the values of the pitches of the flutes 1, 2, 3 causes a relative angular movement of the cutting lips S1, S2, S3 initially on three radii spaced apart from one another by 120° relative to the longitudinal axis of the blade (FIG. 2, FIG. 3A). Along the portion P2, the flute 2 winds around itself by 120° more than the flute 1, the flute 3 winds around itself by 60° more than flute 1. The flute 1 becomes tangential to the flute 2. The cutting lip 1 which is the intersection between the flute 1 and the flute 2 therefore disappears progressively (FIGS. 3A to 3E) and then completely (FIG. 4).

The length L2 of the second portion P2 is, in the example shown, approximately L2=3 to 7 mm (for example 5 mm), its small diameter is of the order of 0.15 to 0.8 mm (for example 0.5 mm) in the vicinity of the first portion P1 and its large diameter is of the order of 0.2 to 1.2 mm (for example 0.8 mm) in the vicinity of the third portion P3. All the geometric characteristics of the second portion (the number of cutting lips, the pitch of the helixes, the cutting angle, the helix angle, the conicity, the length, the tip diameter, etc.) and notably the evolution of the helix pitches of the cutting lips along the second portion, are adjusted to obtain the best distribution of the mechanical stresses in the blade and of the evolution of the number of cutting lips between the first portion P1 and the third portion P3.

In the third cut portion P3, the blade comprises two cutting lips all having identical geometric characteristics at a blade section (FIG. 4):
the same helix pitch,
the same helix angle alpha32=alpha33
the same cutting angle alpha3.

Two sections of the portion P3 may nevertheless have different geometric characteristics.

The length L3 of the third portion P3 is in this instance approximately L3=7 to 11 mm (for example 9.2 mm), its small diameter is of the order of 0.2 to 1.2 mm (for example 0.8 mm) in the vicinity of the second portion P2 and its large diameter is of the order of 0.5 to 1.6 mm (for example 1.2 mm) in the vicinity of the end of the blade. All the geometric characteristics of the third portion (the number of cutting lips, the pitch of the helixes, the cutting angle, the helix angle, the conicity, the length etc.) are adjusted to obtain the best distribution of the mechanical stresses in the blade and a good centering of the blade in the channel to be treated. The helix angles and the cutting angles in the third portion are in this instance greater than those of a portion of blade with third cutting lips so that the cutting efficiency and the capacity to bring up debris are improved.

In the examples shown, the cut blade is extended by a fourth portion P4 that is not cut and is cylindrical, which provides more flexibility to the blade.

In the example shown again, the fourth portion P4 is extended by a mechanical handle P5 allowing the blade to be connected to a rotary driving tool.

Naturally, the reamer represented in the figures is only one example of the reamer according to the invention, in which the number (3) of cutting lips in the vicinity of the tip of the cut blade is greater than the number (2) of lips in the vicinity of the heel of the cut blade. Many variants can be envisaged as a function of the technical characteristics (mechanical strength, torsional force, etc.) that are desired, for example:
a smaller number of cutting lips in the vicinity of the tip of the cut blade than the number of cutting lips in the vicinity of the heel of the cut blade,
at least three blade portions having numbers of lips that differ from one portion to the other, for example one portion with four cutting lips, one portion with three cutting lips and one portion with two cutting lips.

Equally, it is possible to produce reamers having identical technical characteristics, in different embodiments. For example, to produce a reamer comprising 4 cutting lips S1 to S4 at the tip, with cutting lips spaced 90° apart, and two cutting lips at the heel with cutting lips spaced 180° apart, it is possible, along the portion P2, as required:
to cut a flute 1 which winds around itself with the same geometric parameters as in the portion P1, to cut a flute 2 which winds around itself by 90° more than the flute 1, to cut a flute 3 which winds around itself by 180° more than the flute 1, to cut a flute 4 which winds around itself by 90° more than the flute 1; thus, the flutes 3, 4 become tangential to the flute 1 and disappear, and the cutting lips S3, S4 also disappear, or
to cut a flute 1 which winds around itself with the same geometric parameters as in the portion P1, to cut a flute 2 which winds around itself by 90° more than the flute 1, to cut a flute 3 which winds around itself with the same geometric parameters as in the portion P1, to cut a flute 4 which winds around itself by 90° more than the flute 1; thus, the flute 2 becomes tangential to the flute 3 and the flute 4 becomes tangential to the flute 1 so that the flutes 2 and 4, and the cutting lips S2, S4 disappear.

The reamers according to the invention are made by cutting a metal bar of generally conical or cylindrical shape with the aid of a grinder. The helical flutes are cut one after the other from the tip of the blade to the heel, for example:
first the flute 1 (chosen as the reference), with a pitch p1, which may or may not be constant over the whole length L of the blade,
then the flute 2, with a pitch p2=p1 on the portion 1, then p2 which is different from p1 with p2 such that the flute 2 winds around itself by an angle theta2 more than the flute 1 on the portion 2, then p2=p1 on the portion 3,
then the flute 3, with a pitch p3=p1 on the portion 1, then p3 which is different from p1 with p3 such that the flute 3 winds around itself by an angle theta3 more than the flute 1 on the portion 2, then p2=p1 on the portion 3,
etc.

The parameters of the cutting tool, notably the angle of inclination and the speed of movement in translation of the grinder, the speed of movement (in rotation and/or in translation in front of the grinder) of the bar to be cut are adapted for each flute, and for each portion of the blade, in order to obtain the desired flute pitches.

1. A fluted reamer comprising a cut blade comprising a plurality of helical cutting lips, wherein a number of helical cutting lips varies along a longitudinal axis of the cut blade, and wherein the cut blade comprises in turn, along the longitudinal axis of the blade:
a first portion in which the blade comprises a first number of helical lips having first identical geometric characteristics at one section orthogonal to the longitudinal axis,
a second portion in which the blade comprises a second number of helical lips having different geometric characteristics from one lip to the other, the second number being different from the first number, and
a third portion in which the blade comprises a number of helical lips equal to the second number, and in which the helical lips have second identical geometric characteristics at a section orthogonal to the longitudinal axis, the second geometric characteristics being different from the first geometric characteristics.

2. The reamer as claimed in claim 1, wherein, at least on one section of the blade orthogonal to the longitudinal axis of the cut blade, one helix pitch, one helix angle or one cutting angle of a cutting lip is different from the helix pitch, from the helix angle or from the cutting angle of the other cutting lips.

3. The reamer as claimed in claim 1, wherein the cut blade has a generally conical shape.

4. The reamer as claimed in claim 1, wherein the cut blade comprises three cutting lips in the vicinity of the tip of the blade, and two cutting lips in the vicinity of an end opposite to the tip of the blade.

5. The reamer as claimed in claim 1, wherein the cut blade comprises two cutting lips in the vicinity of the tip of the blade, and three cutting lips in the vicinity of an end opposite to the tip of the blade.

6. The reamer as claimed in claim 1, wherein the first geometric characteristics and the second geometric characteristics comprise notably, for each of the helical lips of the blade: one helix pitch, and/or one helix angle and/or one cutting angle.

7. The reamer as claimed in claim 1, wherein the cut blade is extended by a fourth portion that is cylindrical and uncut.

8. The reamer as claimed in claim 1, wherein the cut blade, and optionally the fourth portion, is extended by a manual handle or a mechanical handle allowing the blade to be connected to a rotary driving tool.
